(19) United States
(12) Patent Application Publication
(10) Pub. No.: US 2025/0226598 A1
(43) Pub. Date: Jul. 10, 2025

(54) TERMINAL CONNECTION MODULE AND TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Ryoma TAKAGI, Mie (JP); Toshiro SAKAI, Mie (JP); Masaki NONOGAWA, Mie (JP); Yuya TSUKAMOTO, Mie (JP); Shuya NISHIO, Mie (JP); Akio KIMURA, Mie (JP)

(21) Appl. No.: 18/850,565

(22) PCT Filed: Mar. 17, 2023
(86) PCT No.: PCT/JP2023/010666

§ 371 Date: Sep. 25, 2024

(30) Foreign Application Priority Data
Mar. 30, 2022 (JP) 2022-055480

(51) Int. Cl. H01R 4/48; H01R 4/58

(52) U.S. Cl. CPC H01R 4/48; H01R 4/58

(57) ABSTRACT

A terminal connection module includes: a first terminal including a first terminal connection portion; a second terminal including a second terminal connection portion; and a clamping member configured to clamp the first terminal connection portion and the second terminal connection portion placed in an overlapping state. The first terminal connection portion includes a first terminal contact surface and a first receiving surface, and the second terminal connection portion includes a second terminal contact surface and a second receiving surface. The clamping member includes a first clamping surface and a second clamping surface. A maximum coefficient of friction between the first terminal contact surface and the second terminal contact surface is smaller than at least one out of a maximum coefficient of friction between the first receiving surface and the first clamping surface and a maximum coefficient of friction between the second receiving surface and the second clamping surface.

### DESCRIPTION

### Technical Field

The present disclosure relates to a terminal connection module and a terminal.

### Background

Patent Document 1 discloses a connector which includes a plate-shaped connection terminal, a spring portion, and a housing which is provided with an insertion port, into which a mating terminal is inserted, and which holds the spring portion, the connector being constructed so that a mating terminal that has been inserted into the insertion port and the connection terminal are clamped by the spring portion.

### PRIOR ART DOCUMENT

### Patent Document

Patent Document 1: JP 2021-097055 A

### SUMMARY OF THE INVENTION

### Problems to be Solved

In a configuration where the terminal and the mating terminal are clamped by a spring portion, it is desirable to improve the holding force applied to the terminal or the mating terminal and further increase the wear resistance for the terminal and mating terminal.

For this reason, it is an object of the present disclosure to improve the holding force applied to terminals and further increase the wear resistance of the terminals in a structure where terminals are clamped by a clamping member.

### Means to Solve the Problem

A terminal connection module according to an aspect of the present disclosure includes: a first terminal including a first terminal connection portion; a second terminal including a second terminal connection portion; and a clamping member configured to clamp the first terminal connection portion and the second terminal connection portion which have been placed in an overlapping state, wherein the first terminal connection portion includes a first terminal contact surface, which contacts the second terminal connection portion, and a first receiving surface, which is positioned on an opposite side to the first terminal contact surface and contacts the clamping member, the second terminal connection portion includes a second terminal contact surface, which contacts the first terminal connection portion, and a second receiving surface, which is positioned on an opposite side to the second terminal contact surface and contacts the clamping member, the clamping member includes a first clamping surface that contacts the first receiving surface and a second clamping surface that contacts the second receiving surface, and a maximum coefficient of friction between the first terminal contact surface and the second terminal contact surface is smaller than at least one out of a maximum coefficient of friction between the first receiving surface and the first clamping surface and a maximum coefficient of friction between the second receiving surface and the second clamping surface.

A terminal according to an aspect of the present disclosure includes a terminal connection portion, wherein the terminal connection portion includes a terminal contact surface, which contacts a mating terminal, and a receiving surface, which is positioned on an opposite side to the terminal contact surface and receives a force that presses the terminal contact surface onto the mating terminal, and plating layers of respectively different materials are provided on the terminal contact surface and the receiving surface.

### Effect of the Invention

According to the present disclosure, it is possible, when terminals are clamped by a clamping member, to increase the holding force applied to the terminals and to also improve wear resistance for the terminals.

### BRIEF DESCRIPTION OF THE DRAWINGS

FIG. 1 is an exploded perspective view depicting a terminal connection module according to an embodiment.

FIG. 2 is a cross-sectional view depicting the terminal connection module.

FIG. 3 is a graph depicting changes in a friction coefficient with respect to the sliding distance in Experimental Example 1.

FIG. 4 is a graph depicting changes in a friction coefficient with respect to sliding distance in Experimental Example 2.

FIG. 5 is a graph depicting changes in a friction coefficient with respect to sliding distance in Experimental Example 3.

FIG. 6 is a graph depicting changes in a friction coefficient with respect to sliding distance in Experimental Example 4.

FIG. 7 is a graph depicting changes in a friction coefficient with respect to sliding distance in Experimental Example 5.

FIG. 8 is a graph depicting changes in a friction coefficient with respect to sliding distance in Experimental Example 6.

FIG. 9 is a graph depicting changes in a friction coefficient with respect to sliding distance in Experimental Example 7.

FIG. 10 is a table indicating the relationship between a purity of a silver plating layer and a maximum coefficient of friction.

FIG. 11 is a table depicting whether plating cracks are present in Experimental Examples 10, 11, and 12.

FIG. 12 is a view depicting cracks that occur in a silver plating layer in Experimental Example 10.

FIG. 13 is a graph depicting changes in a friction coefficient with respect to sliding distance in Experimental Example 13.

FIG. 14 is a graph depicting changes in a friction coefficient with respect to sliding distance in Experimental Example 14.

### DETAILED DESCRIPTION TO EXECUTE THE INVENTION

### Outline of Embodiments of the Present Disclosure Several embodiments of the present disclosure will first be listed and described in outline.

A terminal connection module according to an aspect of the present disclosure is as described below.

(1) A terminal connection module includes: a first terminal including a first terminal connection portion; a second terminal including a second terminal connection portion; and a clamping member configured to clamp the first terminal connection portion and the second terminal connection portion which have been placed in an overlapping state, wherein the first terminal connection portion includes a first terminal contact surface, which contacts the second terminal connection portion, and a first receiving surface, which is positioned on an opposite side to the first terminal contact surface and contacts the clamping member, the second terminal connection portion includes a second terminal contact surface, which contacts the first terminal connection portion, and a second receiving surface, which is positioned on an opposite side to the second terminal contact surface and contacts the clamping member, the clamping member includes a first clamping surface that contacts the first receiving surface and a second clamping surface that contacts the second receiving surface, and a maximum coefficient of friction between the first terminal contact surface and the second terminal contact surface is smaller than at least one out of a maximum coefficient of friction between the first receiving surface and the first clamping surface and a maximum coefficient of friction between the second receiving surface and the second clamping surface.

With this terminal connection module, since the maximum coefficient of friction between the first terminal contact surface and the second terminal contact surface is relatively small, wear is less likely to occur at the first terminal contact surface and the second terminal contact surface due to insertion and removal of the first terminal or second terminal and fretting due to thermal cycles or the like. This makes it possible to increase the wear resistance between the first terminal contact surface and the second terminal contact surface. Also, since at least one of the maximum coefficient of friction between the first receiving surface and the first clamping surface and the maximum coefficient of friction between the second receiving surface and the second clamping surface is comparatively large, the holding force applied to at least one of the first terminal and the second terminal can be increased. By doing so, in a terminal connection module in which the first terminal and the second terminal are clamped by a clamping member, it is possible to improve the holding force applied to at least one of the first terminal and the second terminal while further increasing the wear resistance between the first terminal and the second terminal.

(2) In the terminal connection module according to (1) above, a maximum coefficient of friction between the first terminal contact surface and the second terminal contact surface may be smaller than both maximum coefficients of friction out of the maximum coefficient of friction between the first receiving surface and the first clamping surface and the maximum coefficient of friction between the second receiving surface and the second clamping surface.

By doing so, it is possible to increase the holding force on both the first terminal and the second terminal.

(3) In the terminal connection module according to (1) or (2), at least one surface out of the first receiving surface and the second receiving surface may include a high-friction-coefficient plating layer, and the high-friction-coefficient plating layer may be a plating layer that increases a maximum coefficient of friction with respect to the first clamping surface or the second clamping surface compared to when no high-friction-coefficient plating layer is present.

With the above configuration, the high-friction-coefficient plating layer can increase the maximum friction coefficient at at least one of between the first receiving surface and the first clamping surface and between the second receiving surface and the second clamping surface.

(4) In the terminal connection module according to (3) above, the clamping member may be a clip formed of stainless steel, at least one of the first clamping surface and the second clamping surface may be a surface at which the stainless steel is exposed, the high-friction-coefficient plating layer may be a tin plating layer, and the stainless steel and the tin plating layer may make direct contact at at least one of between the first receiving surface and the first clamping surface and between the second receiving surface and the second clamping surface.

In this way, by placing the stainless steel and the tin-plated layer in direct contact, the maximum coefficient of friction can be increased at at least one of between the first receiving surface and the first clamping surface and between the second receiving surface and the second clamping surface.

(5) In the terminal connection module according to any one of (1) to (4) above, each of the first terminal contact surface and the second terminal contact surface may include a low-friction-coefficient plating layer, the low-friction coefficient plating layers may be plating layers that reduce a maximum coefficient of friction between the first terminal contact surface and the second terminal contact surface compared to a configuration where the low-friction coefficient plating layers are not present, and the low-friction-coefficient plating layers may be in direct contact with each other between the first terminal contact surface and the second terminal contact surface.

By doing so, the low friction coefficient plating layers are placed in direct contact with each other between the first terminal contact surface and the second terminal contact surface, which can reduce the maximum friction coefficient between the first terminal contact surface and the second terminal contact surface.

(6) In the terminal connection module according to (5) above, the low-friction coefficient plating layer may be a silver plating layer with a purity of at least 95.0 percent by mass but less than 99.0 percent by mass.

In this way, by having silver plating layers with a purity of 95.0 percent by mass or higher and less than 99.0 percent by mass directly contact each other between the first terminal contact surface and the second terminal contact surface, it is possible to reduce the maximum coefficient of friction between the first terminal contact surface and the second terminal contact surface while suppressing cracking of the plating. It is possible to reduce the maximum coefficient of friction between the first terminal contact surface and the second terminal contact surface while suppressing cracking of the plating.

(7) In the terminal connection module according to any one of (1) to (6) above, oil may be provided between the first terminal contact surface and the second terminal contact surface.

With the configuration described above, the oil can reduce the maximum coefficient of friction between the first terminal contact surface and the second terminal contact surface.

A terminal according to an aspect of the present disclosure is as described below.

(8) A terminal according to an aspect of the present disclosure includes a terminal connection portion, wherein the terminal connection portion includes a terminal contact surface, which contacts a mating terminal, and a receiving surface, which is positioned on an opposite side to the terminal contact surface and receives a force that presses the terminal contact surface onto the mating terminal, and plating layers of respectively different materials are provided on the terminal contact surface and the receiving surface.

With the above configuration, since the terminal contact surface and the receiving surface include plating layers made of respectively different materials, it is easy to make the maximum coefficient of friction between the terminal contact surface and a mating terminal smaller than the maximum coefficient of friction between the receiving surface and a member that presses the receiving surface.

(9) In the terminal according to (8) above, the terminal contact surface may include a silver plating layer with purity of at least 95.0 percent by mass but less than 99.0 percent by mass, and the receiving surface may include a tin plating layer.

With the above configuration, it is easy to suppress cracking of the plating in the silver plating layer while making the maximum coefficient of friction between the terminal contact surface and the mating terminal smaller than the maximum coefficient of friction between the receiving surface and the member that presses the receiving surface.

### Detailed Description of Embodiments of the Present Disclosure

Specific examples of a connection module of a terminal (hereinafter simply, “terminal connection module”) and a terminal will now be described in detail with reference to the attached drawings. Note that the present disclosure is not limited to the illustrated examples and is instead indicated by the range of the patent claims and intended to include all possible changes within the meaning and scope of the patent claims and their equivalents.

### Embodiments

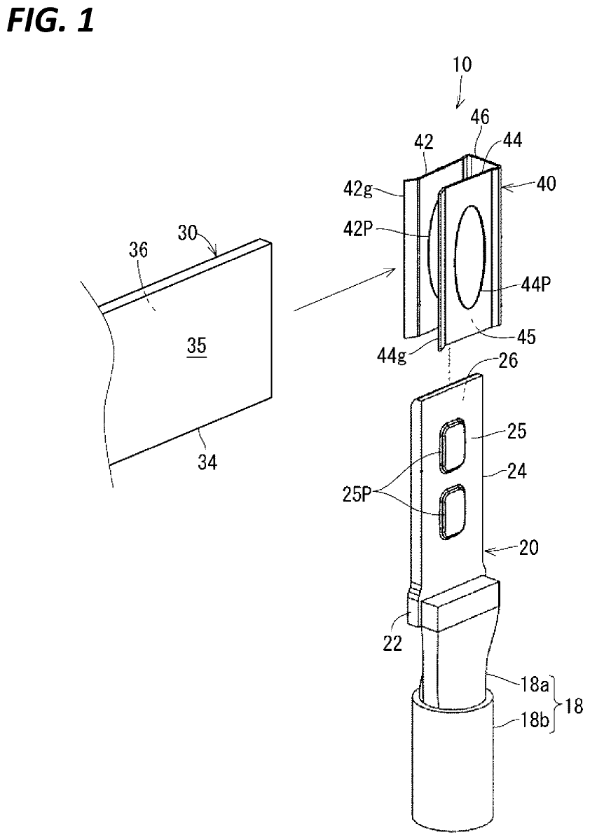

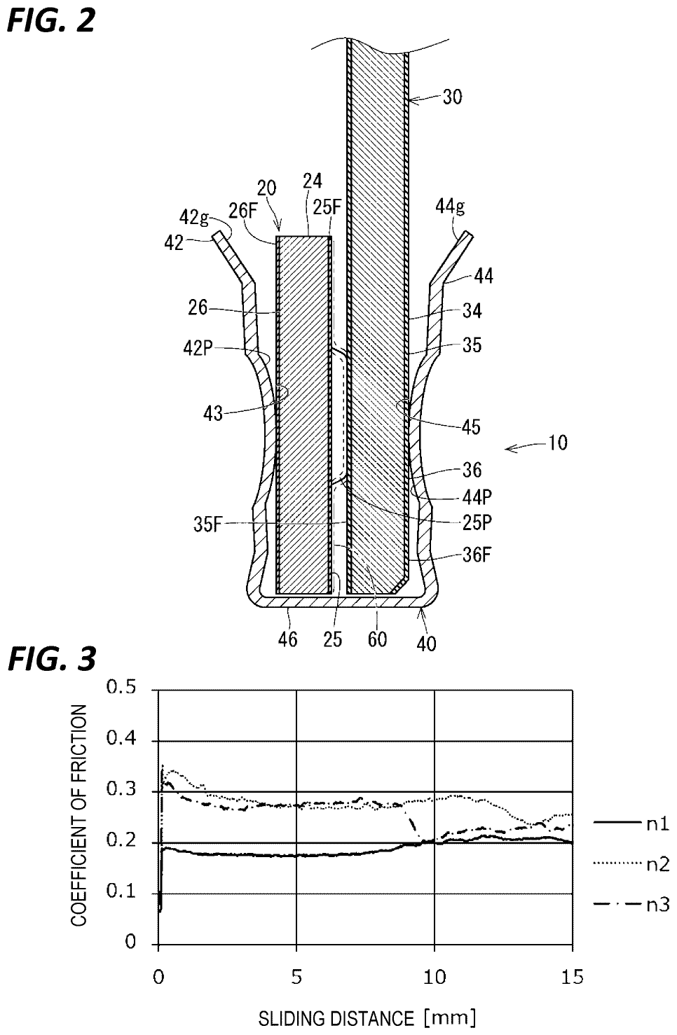

A terminal connection module and a terminal according to embodiments of the present disclosure are described below. FIG. 1 is an exploded perspective view depicting a terminal connection module 10. FIG. 2 is a cross-sectional view depicting the terminal connection module 10.

### <Overall Construction of Terminal Connection Module>

The terminal connection module 10 includes a first terminal 20, a second terminal 30, and a clamping member 40. The terminal connection module 10 is used for example as a component that electrically connects electrical components in a vehicle together.

The first terminal 20 includes a first terminal connection portion 24. As one example, the first terminal 20 is formed by machining metal plate using a press.

In the present embodiment, it is assumed that the first terminal 20 is a terminal that is to be connected to an end of an electric wire 18. As one example, this electric wire 18 is a covered electric wire including a core wire 18a and a covering 18b that covers the core wire 18a. The core wire 18a is exposed at the end of the electric wire 18.

The first terminal 20 includes a wire connection portion 22 that is continuous with the first terminal connection portion 24. The wire connection portion 22 is a part that is connected to the core wire 18a exposed at the end of the electric wire 18. In the present embodiment, the wire connection portion 22 is formed in a plate shape. The core wire 18a is fixed and electrically connected to the wire connection portion 22 through welding, soldering, or the like of the core wire 18a at the end of the electric wire 18 to the wire connection portion 22. The wire connection portion 22 may include a crimping piece that is crimped to the core wire 18a.

It is not essential for the first terminal 20 to be a terminal that is connected to the electric wire 18. The first terminal 20 may instead be directly screwed, soldered, or otherwise connected to a circuit of an electric component.

The first terminal connection portion 24 is formed in a plate shape. In more detail, the first terminal connection portion 24 is formed in a rectangular plate shape that is elongated in one direction. The first terminal connection portion 24 includes a first terminal contact surface 25 and a first receiving surface 26. One main surface of the first terminal connection portion 24 is the first terminal contact surface 25. The main surface of the first terminal connection portion 24 on the opposite side to the first terminal contact surface 25 is the first receiving surface 26. In other words, the first terminal contact surface 25 and the first receiving surface 26 are surfaces that face in opposite directions in the thickness direction of the first terminal connection portion 24.

The first terminal contact surface 25 described above faces a second terminal connection portion 34 and is a surface that comes into contact with the second terminal connection portion 34. The first receiving surface 26 faces the clamping member 40 and is a surface that receives a clamping force applied by the clamping member 40.

In the present embodiment, the first terminal connection portion 24 includes contact portions 25P. There is no particular limitation on the number of these contact portions 25P, but in the present embodiment, a plurality of (here, two) contact portions 25P are formed at an interval in the length direction of the first terminal connection portion 24. The contact portions 25P are parts where the first terminal connection portion 24 partially protrudes on the first terminal contact surface 25 side. This means that the contact portions 25P appear as partially protruding parts when looking from the first terminal contact surface 25 side, and as partially recessed parts when looking from the first receiving surface 26. Peaks where the contact portions 25P protrude by the greatest extent may be formed as flat surfaces. By doing so, it is possible to increase the contact area between the contact portions 25P and the second terminal connection portion 34. There are no particular limitations on the shape of the contact portions 25P, which as examples may be formed as squares, rectangles, ellipses, or the like. The contact portions 25P may have an outer peripheral surface that slopes inwardly toward the peak, which makes it easier for the second terminal connection portion 34 to slide on the outer peripheral surfaces of the contact portions 25P and be guided on the contact portions 25P.

The peaks of the contact portions 25P of the first terminal connection portion 24 are capable of contacting the second terminal connection portion 34. This has effects such as destroying any oxide film on the terminal surface and improving the contact pressure. Note that it is not essential for the contact portions 25P to be formed on the first terminal connection portion 24.

The second terminal 30 includes the second terminal connection portion 34. As one example, the second terminal 30 is formed by machining metal plate using a press.

As one example, like the first terminal 20, the second terminal 30 is a terminal that is connected to an end of an electric wire. The electric wire connection portion of the second terminal 30 is omitted here. It is not essential for the second terminal 30 to be a terminal that is connected to an electric wire, and the second terminal 30 may be a terminal that is connected to a circuit of an electrical component.

The second terminal connection portion 34 is formed in a plate shape. In more detail, the second terminal connection portion 34 is formed as a rectangular plate that is elongated in one direction. The second terminal connection portion 34 includes a second terminal contact surface 35 and a second receiving surface 36. One main surface of the second terminal connection portion 34 is the second terminal contact surface 35. The main surface of the second terminal connection portion 34 on the opposite side to the second terminal contact surface 35 is the second receiving surface 36. In other words, the second terminal contact surface 35 and the second receiving surface 36 are surfaces that face in opposite directions in the thickness direction of the second terminal connection portion 34.

The second terminal contact surface 35 described above faces the first terminal connection portion 24 and is a surface that comes into contact with the first terminal connection portion 24. The second receiving surface 36 faces the clamping member 40 and is a surface that receives the clamping force applied by the clamping member 40.

In the present embodiment, the second terminal connection portion 34 and the second receiving surfaces 36 on both sides of the second terminal connection portion 34 are formed as flat surfaces. Like the first terminal connection portion 24, the second terminal connection portion 34 may include contact portions that protrude toward the first terminal connection portion 24.

The clamping member 40 is a member that clamps the first terminal connection portion 24 and the second terminal connection portion 34 that have been placed over one another. As one example, the clamping member 40 is formed by machining metal plate using a press. The clamping member 40 may be a member called a “clip”.

In more detail, the clamping member 40 includes a first clamping piece 42, a second clamping piece 44, and a connecting piece 46.

The first clamping piece 42 is formed in a plate shape, and in more detail, in the shape of a rectangular plate that is elongated in one direction. The first clamping piece 42 has a first clamping surface 43 that faces the first receiving surface 26, with this first clamping surface 43 contacting the first receiving surface 26.

In the present embodiment, the first clamping piece 42 includes a first pressing portion 42P. The first pressing portion 42P is formed by causing part of the first clamping piece 42 to protrude inward. The first pressing portion 42P protrudes in the form of an elongated dome and has a peak formed as a gradually spherical shape that is close to a flat surface. The shape of the first pressing portion 42P can be freely chosen. It is not essential for this first pressing portion 42P to be formed.

The second clamping piece 44 is formed in a plate shape, and in more detail, in the shape of a rectangular plate that is elongated in one direction. The second clamping piece 44 includes a second clamping surface 45 that faces the second receiving surface 36, with this second clamping surface 45 contacting the second receiving surface 36.

In the present embodiment, the second clamping piece 44 includes a second pressing portion 44P. The second pressing portion 44P is formed by causing part of the second clamping piece 44 to protrude inward. The second pressing portion 44P protrudes in the form of an elongated dome and has a peak formed as a gradually spherical shape that is close to a flat surface. The shape of the second pressing portion 44P can be freely chosen. It is not essential for the second pressing portion 44P to be formed.

Front edges of the first clamping piece 42 and the second clamping piece 44 on the opposite side to the parts that are connected to the connecting piece 46 are formed as guide edges 42g and 44g that are outwardly inclined in directions away from each other. These guide edges 42g and 44g make it possible to easily guide the first terminal connection portion 24 and the second terminal connection portion 34 between the first clamping piece 42 and the second clamping piece 44.

The connecting piece 46 is connected to the base ends of the first clamping piece 42 and the second clamping piece 44 and connects the first clamping piece 42 and the second clamping piece 44 so as to be parallel with a gap in between. In other words, the first clamping piece 42, the connecting piece 46, and the second clamping piece 44 are connected to form a U-shape.

Through elastic deformation of the joins between the first clamping piece 42 and second clamping piece 44 to the connecting piece 46 and elastic deformation of the connecting piece 46 itself, the gap between the first clamping piece 42 and the second clamping piece 44 can be changed.

The minimum distance between the first clamping piece 42 and the second clamping piece 44 is smaller than the sum of the thickness of the first terminal connection portion 24 and the thickness of the second terminal connection portion 34. This means that by elastically deforming the clamping member 40 to widen the gap between the first clamping piece 42 and the second clamping piece 44, it is possible to place a structure produced by placing the first terminal contact surface 25 and the second terminal connection portion 34 over one another between the first clamping piece 42 and the second clamping piece 44. In this state, due to the elastic force of the clamping member 40 that tries to restore the clamping member 40 to its original shape, the first clamping surface 43 presses the first receiving surface 26 and the second clamping surface 45 presses the second receiving surface 36. As a result, the first terminal connection portion 24 and the second terminal connection portion 34 are pressed toward each other, and the first terminal contact surface 25 and the second terminal contact surface 35 come into contact in a state where the first terminal contact surface 25 and the second terminal contact surface 35 are pressed against each other. By doing so, the first terminal 20 and the second terminal 30 become electrically connected.

Note that it is not essential for the clamping member 40 to use the configuration described above. It is not essential for the clamping member to be electrically conductive, and as examples the clamping member 40 may be formed of resin or a combination of resin and metal.

### <Contact Points on Terminal Connection Module>

The first terminal 20 and the second terminal 30 described above are parts through which electricity flows and would conceivably use a material with superior electrical conductivity. As one example, the first terminal 20 and the second terminal 30 could conceivably be made of copper or copper alloy.

Out of the first terminal 20 and the second terminal 30 described above, the first terminal contact surface 25 and the second terminal contact surface 35 are surfaces that contact each other to produce an electrical connection. For this reason, to suppress oxidation of the first terminal contact surface 25 and the second terminal contact surface 35 and to maintain a favorable electrical connection between the first terminal contact surface 25 and the second terminal contact surface 35, the first terminal contact surface 25 and the second terminal contact surface 35 are each assumed to have a plating layer. The plating layers used for this purpose are assumed to be silver plating layers, tin plating layers, or the like. On the other hand, the first receiving surface 26 and the second receiving surface 36 are surfaces that receive the force applied by the clamping member 40 and it is not particularly important whether the first receiving surface 26 and the second receiving surface 36 maintain favorable electrical connections with the clamping member 40. For this reason, it is assumed that a base material forming the first terminal 20 and the second terminal 30 is left exposed as it is at the first receiving surface 26 and the second receiving surface 36, which results in the first receiving surface 26 and the second receiving surface 36 being surfaces at which copper or copper alloy is exposed.

The clamping member 40 is conceivably formed of a material with superior springiness to hold the first terminal 20 and the second terminal 30 in the clamped state. As one example, the clamping member 40 may be formed of stainless steel (including, for example, stainless steel classified as “SUS” according to JIS standard), and in particular, stainless steel used in spring manufacturing.

With the configuration described above, the contact points between the first terminal contact surface 25 and the second terminal contact surface 35 (hereinafter sometimes referred to as “inter-terminal contact points”) will be contact points between the silver plating layers. The contact points between the first receiving surface 26 and the first clamping surface 43 and the contact points between the second receiving surface 36 and the second clamping surface 45 (hereinafter, the contact points between the terminals 20 and 30 and the clamping member 40 are referred to as the “clamping contact points”) are contact points between copper or copper alloy surfaces and stainless steel surfaces.

The present inventors have discovered that with the assumed example configurations of contact points described above, it is difficult to achieve both an increase in the holding force with which the clamping member 40 holds the first terminal 20 or the second terminal 30 and an increase in the wear resistance for the first terminal 20 and the second terminal 30.

The reason for this is as follows. With the surface materials used in the assumed examples, the maximum coefficient of friction at the inter-terminal contact points between the terminals is greater than the maximum coefficient of friction at the clamping contact points.

The inter-terminal contact points need to have sufficient wear resistance to withstand abrasion caused by the insertion and removal of the terminals and fretting abrasion due to thermal cycles or the like. If the maximum coefficient of friction is large, wear caused by insertion and removal of the terminals and wear caused by fretting abrasion due to thermal cycles or the like are more likely to occur, which tends to lower the wear resistance. For this reason, it is preferable to reduce the maximum coefficient of friction at the inter-terminal contact points to increase the wear resistance.

The clamping contact points need sufficient holding performance to prevent movement of the terminals 20 and 30 and withstand forces or vibration in the insertion/removal direction of the terminals 20 and 30. When the maximum coefficient of friction is small, it becomes easy for the terminals 20 and 30 to move between the clamping members 40 and the holding performance tends to be poor. For this reason, it is preferable to increase the maximum coefficient of friction at the clamping contact points to improve holding performance.

For the assumed example configurations described above, it was found that the maximum coefficient of friction at the inter-terminal contact points was greater than the maximum coefficient of friction at the clamping contact points, which is contrary to the requirement described above relating to what is believed to be a preferable maximum coefficient of friction.

For this reason, the inventors of the present application focused on a fact that it is sufficient to make the maximum coefficient of friction pa between the first terminal contact surface 25 and the second terminal contact surface 35 smaller than at least one of the maximum coefficient of friction μb1 between the first receiving surface 26 and the first clamping surface 43 and the maximum coefficient of friction μb2 between the second receiving surface 36 and the second clamping surface 45, and that it is preferable to make the maximum coefficient of friction μa smaller than both the maximum coefficient of friction μb1 and the maximum coefficient of friction μb2.

Here, the maximum coefficient of friction between a first member and a second member may, for example, be the maximum value of the coefficient of friction that is measured when the second member is pulled away from the first member while applying a constant load. As one example, the maximum value may be the maximum value within a sliding distance range of 15 mm or less. The coefficient of friction may be measured by a method that conforms to the Japan Copper and Brass Association Technical Standard (JCBA T311: 2002) for example.

In one conceivable configuration that achieves the above object, the first terminal contact surface 25 and the second terminal contact surface 35 have low-friction-coefficient plating layers 25F and 35F, respectively. These low-friction-coefficient plating layers 25F and 35F are plating layers that reduce the maximum coefficient of friction μa between the first terminal contact surface 25 and the second terminal contact surface 35 compared to when the low-friction-coefficient plating layers 25F and 35F are not provided. It is also possible to place the low-friction-coefficient plating layers 25F and 35F in direct contact with each other between the first terminal contact surface 25 and the second terminal contact surface 35.

One example of the low-friction-coefficient plating layers 25F and 35F described above may be silver plating layers with a purity of 95.0 percent by mass or higher and less than 99.0 percent by mass. This is because a silver plating layer where the purity of the silver is less than 95.0 percent by mass is brittle and prone to the plating cracking. It is believed that cracking will be especially likely when the contact portions 25P are formed. If the plating cracks, the undercoat plating or the base material may become exposed and the contact resistance at the inter-terminal contact points may increase. When the purity of the silver exceeds 99.0 percent by mass, the maximum coefficient of friction μa tends to increase. Aside from silver, a silver plating layer with a purity of 95.0 percent by mass or higher and less than 99.0 percent by mass may include organic compounds, S (sulfur)-containing substances, and/or additives.

To reduce the maximum coefficient of friction pa at the inter-terminal contact points, oil 60 may be provided between the first terminal contact surface 25 and the second terminal contact surface 35 (see the chain double-dashed line in FIG. 2). The lubrication effect achieved by the oil 60 can lower the maximum coefficient of friction pa at the inter-terminal contact points.

By doing so, the maximum coefficient of friction μa at the inter-terminal contact points is reduced, which improves the wear resistance.

In addition to or in place of the configuration described above for reducing the maximum coefficient of friction μa at the inter-terminal contact points, it is possible to provide at least one surface out of the first receiving surface 26 and the second receiving surface 36 with a high-friction-coefficient plating layer 26F and/or 36F. Such high-friction-coefficient plating layers 26F and 36F are plating layers that increase the maximum coefficient of friction for the second clamping surface 45 or the second clamping surface 45 compared to when no high friction coefficient plating layer is provided.

In more detail, as one example, it would be conceivable for the clamping member 40 to be a clip formed of stainless steel, where at least one of the first clamping surface 43 and the second clamping surface 45 is a surface where the stainless steel is exposed and the high-friction-coefficient plating layers 26F and 36F are tin plating layers. It is also conceivable for stainless steel and a tin plating layer to be in direct contact at at least one of between the first receiving surface 26 and the first clamping surface 43 and between the second receiving surface 36 and the second clamping surface 45.

Note that a plating layer for increasing the maximum coefficient of friction may be formed on the clamping surfaces 43 and 45 of the clamping member 40. By doing so, it is possible to increase the maximum coefficients of friction μb1 and μb2 at the clamping contact points, which increases the holding force that holds the terminals 20 and 30.

As one example, a configuration is used where silver plating layers with a purity of at least 95.0 percent by mass and less than 99.0 percent by mass are used as the low-friction-coefficient plating layers 25F and 35F and silver plating layers of this purity are placed in contact with each other at the inter-terminal contact points, tin plating layers are additionally used as the high-friction-coefficient plating layers 26F and 36F, and such tin plating layers and stainless steel surfaces are placed in contact at the clamping contact points, which makes it easy to make the maximum coefficient of friction pa at the inter-terminal contact points smaller than the maximum coefficients of friction μb1 and μb2 at the clamping contact points.

### <Effects>

With the terminal connection module 10 that is configured as described above, since the maximum coefficient of friction μa between the first terminal contact surface 25 and the second terminal contact surface 35 is comparatively small, wear caused by insertion/removal of the first terminal 20 or the second terminal 30 and fretting due to thermal cycles is unlikely to occur at the first terminal contact surface 25 and the second terminal contact surface 35. By doing so, it is possible to increase the wear resistance between the first terminal contact surface 25 and the second terminal contact surface 35. Since at least one of the maximum coefficient of friction μb1 between the first receiving surface 26 and the first clamping surface 43 and the maximum coefficient of friction μb2 between the second receiving surface 36 and the second clamping surface 45 is comparatively large, the holding force of the clamping member 40 that holds at least one of the first terminal 20 and the second terminal 30 can be increased. By doing so, it becomes difficult for the first terminal 20 or the second terminal 30 to come out of the clamping member 40. Increasing the maximum coefficients of friction μb1 and μb2 also contributes to the first terminal 20 and the second terminal 30 becoming less susceptible to moving and is therefore useful in improving wear resistance. In the terminal connection module 10 where the first terminal 20 and the second terminal 30 are clamped by the clamping member 40, it is possible to further improve wear resistance between the first terminal 20 and the second terminal 30 while increasing the holding force on at least one of the first terminal 20 and the second terminal 30.

In particular, by making both of the maximum coefficients of friction μb1 and μb2 larger than the maximum coefficient of friction μa, both of the first terminal 20 and the second terminal 30 become less susceptible to coming out of the clamping member 40.

As one example, by providing the high-friction-coefficient plating layers 26F and 36F on at least one surface out of the first receiving surface 26 and the second receiving surface 36, the maximum coefficient of friction μb1 or the maximum coefficient of friction μb2 can be increased.

Tin plating layers are used as the high-friction-coefficient plating layers 26F and 36F, and by having a surface of stainless steel, which is the base material of the clamping member 40, directly contact the high friction coefficient plating layers 26F and 36F, which are tin plating layers, at at least one of between the first receiving surface 26 and the first clamping surface 43 and between the second receiving surface 36 and the second clamping surface 45, the maximum coefficient of friction μb1 or the maximum coefficient of friction μb2 can be increased.

As another example, it is possible to lower the maximum coefficient of friction μa by providing the first terminal contact surface 25 and the second terminal contact surface 35 with the low-friction-coefficient plating layers 25F and 35F respectively.

By using silver plating layers with a purity of at least 95.0 percent by mass and less than 99.0 percent by mass as the low-friction-coefficient plating layers 25F and 35F, it is possible to lower the maximum coefficient of friction μa while suppressing cracking of the plating in the low-friction-coefficient plating layers 25F and 35F.

Regardless of whether the low-friction-coefficient plating layers 25F and 35F described above are provided, it is possible to reduce the maximum coefficient of friction ua by providing the oil 60 between the first terminal contact surface 25 and the second terminal contact surface 35.

In addition, by using, for a configuration where the terminal 20 (or 30) includes the terminal contact surface 25 (or 35) and the receiving surface 26 (or 36), a configuration where the terminal contact surface 25 (or 35) and the receiving surface 26 (or 36) are provided with plating layers of different materials (for example, a combination of a low-friction-coefficient plating layer 25F and a high-friction-coefficient plating layer 26F), it is easy to make the maximum coefficient of friction μa between the terminal contact surface 25 (or 35) and the mating terminal 30 (or 20) smaller than the maximum coefficient of friction μb1 (or μb2) between the receiving surface 26 (or 36) and the clamping member 40 that presses that receiving surface.

In this case, as described above, if the terminal contact surface 25 (or 35) has a silver plating layer with a purity of at least 95.0 percent by mass and less than 99.0 percent by mass, and the receiving surface 26 (or 36) has a tin plating layer, it is easy to make the maximum coefficient of friction μa smaller than the maximum coefficient of friction μb1 (or μb2).

Note that the configurations described in the above embodiment and modifications can be combined as appropriate as long as they are not technically inconsistent.

### EXPERIMENTAL EXAMPLES

### Experimental Examples of Clamping Contact Points

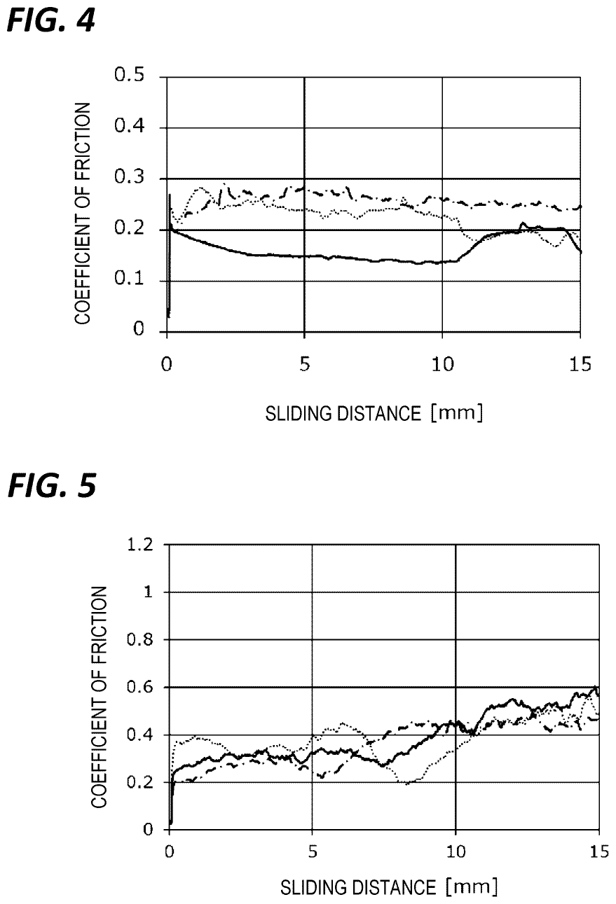

The coefficient of friction between stainless steel and copper plate was measured as Experimental Examples 1 and 2. In Experimental Example 1, the copper plate was formed into the same shape as the second terminal 30 described above. In Experimental Example 2, the copper plate was formed into the same shape as the first terminal 20. The change in the coefficient of friction with respect to the sliding distance in Experimental Example 1 is depicted in FIG. 3. The change in the coefficient of friction with respect to the sliding distance in Experimental Example 2 is depicted in FIG. 4. Note that each curve in FIG. 3 indicates the measurement results for a plurality of samples. A legend indicating the correspondence between each curve and the sample number (n1, n2, n3) is provided in FIG. 3, but is omitted from the subsequent drawings.

In FIG. 3, the maximum coefficient of friction was around 0.36, and in FIG. 4, the maximum coefficient of friction was around 0.29. From FIG. 3 and FIG. 4, it was established that the maximum coefficient of friction between stainless steel and copper plate is a comparatively small value. Note that from FIG. 3 and FIG. 4, it was found that the shape of the copper plate, or more specifically, whether the contact portions 25P were provided as on the first terminal 20 or not provided as on the second terminal 30, does not greatly affect the coefficient of friction.

This means that when copper is exposed at the first receiving surface 26 and the second receiving surface 36 and stainless steel is exposed at the first clamping surface 43 and the second clamping surface 45, the maximum coefficients of friction μb1 and μb2 will be small and the holding force of the first terminal 20 and the second terminal 30 is expected to be low.

Note that the expression “maximum coefficient of friction” fundamentally refers to a maximum value of the coefficient of friction between specific objects. In the description of these experimental examples, to evaluate the maximum coefficient of friction between objects with specific physical properties, when the coefficient of friction has been measured a plurality of times, the highest value out of such plurality of measurement results is regarded as the maximum coefficient of friction.

As Experimental Example 3, the coefficient of friction between stainless steel and copper plate on which a tin plating layer has been formed was measured. Changes in the coefficient of friction with respect to the sliding distance in Experimental Example 3 are depicted in FIG. 5.

As can be understood from FIG. 5, the maximum coefficient of friction between stainless steel and copper plate with a tin plating layer is around 0.6. This means that when tin plating layers are formed on the first receiving surface 26 and the second receiving surface 36 and stainless steel is exposed at the first clamping surface 43 and the second clamping surface 45, the maximum coefficients of friction μb1 and μb2 are expected to increase and the holding force on the terminals 20 and 30 can be improved. In this way, it was established that tin plating layers can be used as one example of the high friction coefficient plating layers 26F and 36F described above.

### Experimental Examples Relating to Inter-Terminal Contact Points

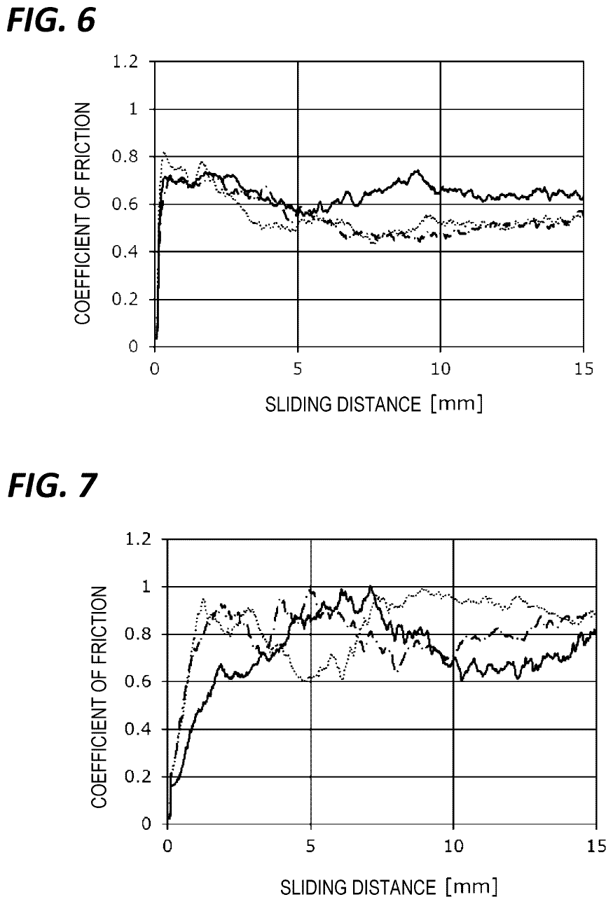

As Experimental Example 4, the coefficient of friction between two copper plates provided with tin plating layers was measured. As Experimental Example 5, the coefficient of friction between copper plates including silver plating layers with a silver purity of 99 percent by mass or higher was measured. In Experimental Examples 4 and 5, one copper plate was formed in the same shape as the first terminal 20, and the other copper plate was formed in the same shape as the second terminal 30. The change in the coefficient of friction with respect to the sliding distance in Experimental Example 4 is depicted in FIG. 6. The change in the coefficient of friction with respect to the sliding distance in Experimental Example 5 is depicted in FIG. 7.

As can be understood from FIG. 6, the maximum coefficient of friction between two copper plates with tin plating layers was around 0.82. As can be understood from FIG. 7, the maximum coefficient of friction between copper plates with silver plating layers with a purity of 99 percent by mass or higher was around 1.00.

For this reason, when a tin plating layer is formed or when a silver plating layer with a purity of 99 percent by mass or higher is formed on the first terminal contact surface 25 and the second terminal contact surface 35, the maximum coefficient of friction μa is expected to increase, which would result in lower wear resistance.

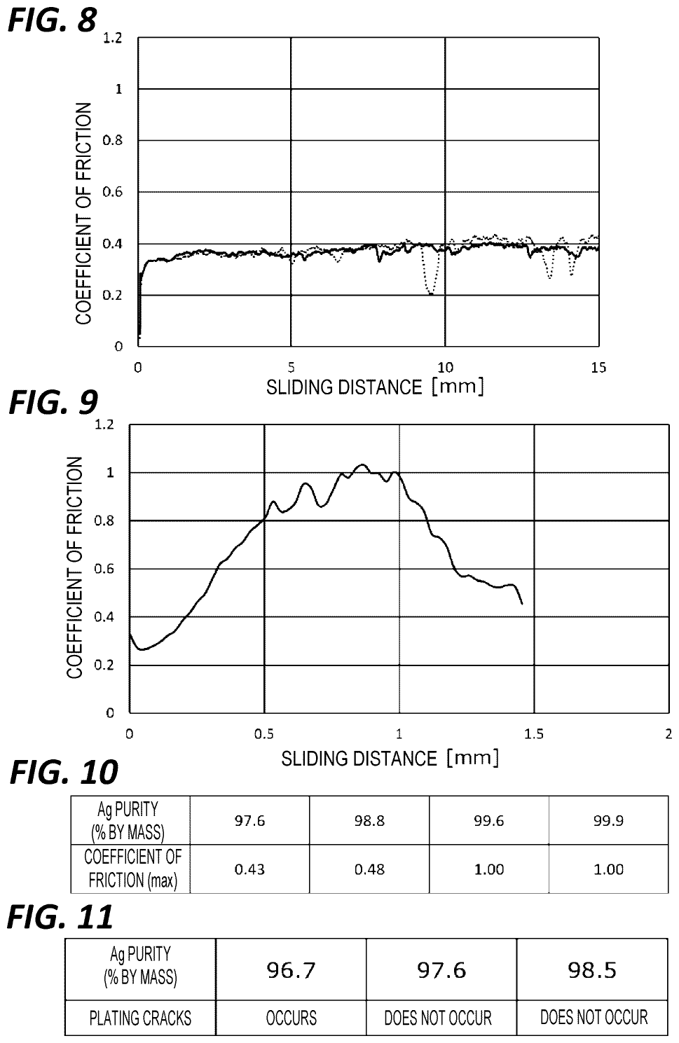

As Experimental Example 6, the coefficient of friction between copper plates with silver plating layers with a silver purity of 97.6 percent by mass was measured. Note that one copper plate was formed in the same shape as the first terminal 20, and the other copper plate was formed in the same shape as the second terminal 30. The changes in the coefficient of friction with respect to the sliding distance in Experimental Example 6 are indicated in FIG. 8.

As can be understood from FIG. 8, the maximum coefficient of friction between the copper plates with silver plating layers with a silver purity of 97.6 percent by mass was a small value of 0.43.

For this reason, when silver plating layers with a silver purity of 97.6 percent by mass are formed on the first terminal contact surface 25 and the second terminal contact surface 35, the maximum coefficient of friction μa is expected to be small, which improves wear resistance. It has therefore been found that silver plating layers with a purity of 97.6 percent by mass can be used as one example of the low-friction-coefficient plating layers 25F and 35F described above.

As Experimental Example 7, the coefficient of friction between copper plates with silver plating layers with a silver purity of 99.6 percent by mass was measured. The change in the friction coefficient with respect to the sliding distance in Experimental Example 7 is indicated in FIG. 9.

As can be understood from FIG. 9, the maximum coefficient of friction between copper plates with silver plating layers with a silver purity of 99.6 percent by mass was 1.00.

As Experimental Example 8, the coefficient of friction between copper plates with silver plating layers with a silver purity of 98.8 percent by mass was measured to determine the maximum coefficient of friction. As Experimental Example 9, the coefficient of friction between copper plates with silver plating layers with a silver purity of 99.9 percent by mass was measured to determine the maximum coefficient of friction.

The maximum coefficient of friction relative to the purity of silver is indicated in FIG. 10. From FIG. 10, it can be understood that the maximum coefficient of friction is small when the purity of silver is less than 99 percent by mass and the maximum coefficient of friction increases sharply when the purity of silver exceeds 99 percent by mass. In this way, it was found that if the purity of silver is less than 99 percent by mass, the maximum coefficient of friction between copper plates with silver plating layers can be reduced, and such silver plating layers can be used as the low-friction-coefficient plating layers 25F and 35F.

As one example, when tin plating layers are used as the high-friction-coefficient plating layers 26F and 36F, the maximum coefficient of friction is 0.60, and when silver plating layers with a silver purity of less than 99% are used as the low-friction-coefficient plating layers 25F and 35F, the maximum coefficient of friction is clearly smaller than 0.60. Accordingly, this combination of plating layers is a suitable example of where the maximum coefficient of friction μa is smaller than at least one and preferably both of the maximum coefficients of friction μb1 and μb2.

In addition, as Experimental Examples 10, 11, and 12, copper plate on which a silver plating layer had been formed was machined to form the contact portions 25P, and the occurrence of plating cracks was observed. In Experimental Example 10, a silver plating layer with a purity of 96.7 percent by mass was formed, in Experimental Example 11, a silver plating layer with a purity of 97.6 percent by mass was formed, and in Experimental Example 12, a silver plating layer with a purity of 98.5 percent by mass was formed. The presence or absence of cracks in the plating for each of Experimental Examples 10, 11, and 12 is indicated in FIG. 11.

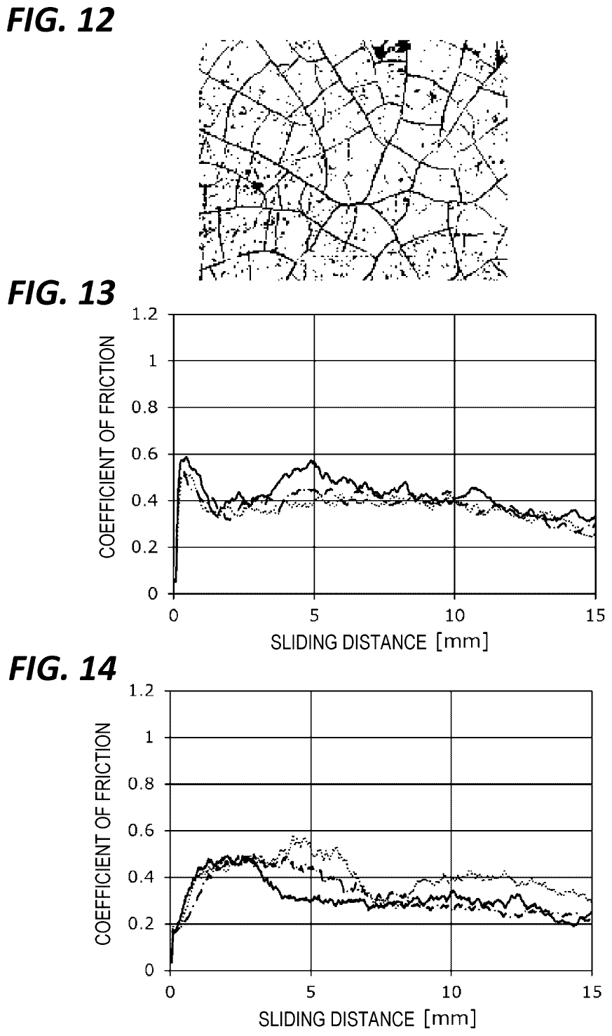

A micrograph of the surface of a test piece in Experimental Example 10 (whose silver purity is 96.7 percent by mass) is depicted in FIG. 12. As depicted in the drawing, in the case of Experimental Example 10 (whose silver purity is 96.7 percent by mass), a large number of fine cracks were observed in the surface of the silver plating layer. In contrast, for Experimental Example 11 (whose silver purity is 97.6 percent by mass) and Experimental Example 12 (whose silver purity is 98.5 percent by mass), no plating cracks were observed.

For this reason, it was found that if the purity of silver is 97 percent by mass or higher, plating cracks are unlikely to occur even when machining is performed to form the contact portions 25P or the like, making this suitable for use as the low-friction-coefficient plating layers 25F and 35F.

As Experimental Example 13, the friction coefficient was measured when oil was provided between the tin plating layers in Experimental Example 4. As Experimental Example 14, the friction coefficient was measured when oil was provided between the silver plating layers in Experimental Example 5. The change in the friction coefficient with respect to the sliding distance in Experimental Example 13 is indicated in FIG. 13. The change in friction coefficient with respect to the sliding distance in Experimental Example 14 is indicated in FIG. 14. In Experimental Example 13, the maximum coefficient of friction was around 0.59. In Experimental Example 14, the maximum coefficient of friction was around 0.58.

In this way, it was established that when oil is provided between the first terminal contact surface 25 and the second terminal contact surface 35, the maximum coefficient of friction μa can be reduced compared to when no oil is present. Accordingly, depending on the values of the maximum coefficients of friction μb1 and μb2, the maximum coefficient of friction μa can be made smaller than the maximum coefficients of friction μb1 and μb2 by providing oil between the first terminal contact surface 25 and the second terminal contact surface 35.

### LIST OF REFERENCE NUMERALS

10 Connection module

18 Electric wire

18a Core wire

18b Covering

20 First terminal

22 Wire connection portion

24 First terminal connection portion

25 First terminal contact surface

25F Low-friction-coefficient plating layer

25P Contact portion

26 First receiving surface

26F High-friction-coefficient plating layer

30 Second terminal

34 Second terminal connection portion

35 Second terminal contact surface

35F Low-friction-coefficient plating layer

36 Second receiving surface

36F High-friction-coefficient plating layer

40 Clamping member

42 First clamping piece

42P First pressing portion

42g, 44g Guide edge

43 First clamping surface

44 Second clamping piece

44P Second pressing portion

45 Second clamping surface

46 Connecting piece

60 Oil

1. A terminal connection module comprising:
a first terminal including a first terminal connection portion;
a second terminal including a second terminal connection portion; and
a clamping member configured to clamp the first terminal connection portion and the second terminal connection portion which have been placed in an overlapping state,
wherein the first terminal connection portion includes a first terminal contact surface, which contacts the second terminal connection portion, and a first receiving surface, which is positioned on an opposite side to the first terminal contact surface and contacts the clamping member,
the second terminal connection portion includes a second terminal contact surface, which contacts the first terminal connection portion, and a second receiving surface, which is positioned on an opposite side to the second terminal contact surface and contacts the clamping member,
the clamping member includes a first clamping surface that contacts the first receiving surface and a second clamping surface that contacts the second receiving surface, and
a maximum coefficient of friction between the first terminal contact surface and the second terminal contact surface is smaller than at least one out of a maximum coefficient of friction between the first receiving surface and the first clamping surface and a maximum coefficient of friction between the second receiving surface and the second clamping surface.

2. The terminal connection module according to claim 1,
wherein a maximum coefficient of friction between the first terminal contact surface and the second terminal contact surface is smaller than both maximum coefficients of friction out of the maximum coefficient of friction between the first receiving surface and the first clamping surface and the maximum coefficient of friction between the second receiving surface and the second clamping surface.

3. The terminal connection module according to claim 1,
wherein at least one surface out of the first receiving surface and the second receiving surface includes a high-friction-coefficient plating layer, and
the high-friction-coefficient plating layer is a plating layer that increases a maximum coefficient of friction with respect to the first clamping surface or the second clamping surface compared to when no high-friction-coefficient plating layer is present.

4. The terminal connection module according to claim 3,
wherein the clamping member is a clip formed of stainless steel,
at least one of the first clamping surface and the second clamping surface is a surface at which the stainless steel is exposed,
the high-friction-coefficient plating layer is a tin plating layer, and
the stainless steel and the tin plating layer make direct contact at at least one of between the first receiving surface and the first clamping surface and between the second receiving surface and the second clamping surface.

5. The terminal connection module according to claim 1,
wherein each of the first terminal contact surface and the second terminal contact surface includes a low-friction-coefficient plating layer,
the low-friction coefficient plating layers are plating layers that reduce a maximum coefficient of friction between the first terminal contact surface and the second terminal contact surface compared to a configuration where the low-friction coefficient plating layers are not present, and
the low-friction-coefficient plating layers are in direct contact with each other between the first terminal contact surface and the second terminal contact surface.

6. The terminal connection module according to claim 5,
wherein the low-friction coefficient plating layer is a silver plating layer with a purity of at least 95.0 percent by mass but less than 99.0 percent by mass.

7. The terminal connection module according to claim 1,
wherein oil is provided between the first terminal contact surface and the second terminal contact surface.

8. A terminal comprising a terminal connection portion,
wherein the terminal connection portion includes a terminal contact surface, which contacts a mating terminal, and a receiving surface, which is positioned on an opposite side to the terminal contact surface and receives a force that presses the terminal contact surface onto the mating terminal, and
plating layers of respectively different materials are provided on the terminal contact surface and the receiving surface.

9. The terminal according to claim 8,
wherein the terminal contact surface includes a silver plating layer with purity of at least 95.0 percent by mass but less than 99.0 percent by mass, and
the receiving surface includes a tin plating layer.
